(19) United States
(12) Patent Application Publication
(10) Pub. No.: US 2023/0271150 A1
(43) Pub. Date: Aug. 31, 2023

(54) HIGH TEMPERATURE THERMAL PROCESS SYSTEMS

(71) Applicant: Honeywell International Inc., Charlotte, NC (US)

(72) Inventors: Stephen Yates, South Barrington, IL (US); Amanda Childers, Arlington Heights, IL (US); Mehrad Mehr, Morristown, NJ (US); Jeffrey Spencer, Gilbert, AZ (US); Jason Smoke, Phoenix, AZ (US); Abigail Parsons, South Bend, IN (US)

(21) Appl. No.: 17/931,441

(22) Filed: Sep. 12, 2022

Related U.S. Application Data
(60) Provisional application No. 63/268,579, filed on Feb. 25, 2022.

(51) Int. Cl. B01J 6/00; C01B 3/24

(52) U.S. Cl. CPC B01J 6/008; C01B 3/24; C01B 2203/0272; C01B 2203/1241

(57) ABSTRACT

A thermal process system includes a retort assembly, a heating assembly, and a vessel housing. The retort assembly includes a retort chamber and is configured to substantially form a containment boundary to contain one or more gases in the retort chamber during a thermal process. The heating assembly includes one or more heating elements and is configured to heat the retort chamber. The vessel housing is positioned around the retort chamber and the one or more heating elements and configured to form a pressure boundary to maintain a pressure within the retort chamber and reduce a pressure across the retort chamber.

This application claims the benefit of U.S. Provisional application No. 63/268,579, entitled “HIGH TEMPERATURE THERMAL PROCESS SYSTEMS” and filed on Feb. 25, 2022, which is incorporated herein by reference in its entirety.

### GOVERNMENT RIGHTS

This invention was made with Government support under Grant Contract Number 80MSFC21CA010 awarded by NASA. The Government has certain rights in the invention.

### TECHNICAL FIELD

The present disclosure relates to systems and techniques for maintaining thermal process conditions.

### BACKGROUND

An environmental control system (ECS) of a structure, such as a building or vehicle, may remove carbon dioxide expelled by occupants of an environment, such as a room or cabin, to maintain comfort and safety. In some instances, the carbon dioxide may be absorbed from the environment by a liquid sorbent and desorbed from the liquid sorbent for discharge from the structure. However, for an atmosphere limited structure, such as a spacecraft or submarine, such discharge of carbon dioxide may waste oxygen from the carbon dioxide that may otherwise be recovered. To extract oxygen from the carbon dioxide, the ECS may react the carbon dioxide with hydrogen gas to form methane and water through a Sabatier reaction. Oxygen is then produced from the water by electrolysis. The ECS may produce at least a portion of this hydrogen gas by pyrolyzing methane. Methane pyrolysis occurs at a relatively high temperature, and may require a large amount of power to compensate for heat losses and large and/or heavy equipment to seal the gases.

### SUMMARY

In general, the disclosure describes thermal process systems, such as reactor systems, configured to maintain high temperature and pressurized (e.g., pressures above or below ambient) conditions for power, weight, and/or size sensitive applications, such as methane pyrolysis conditions for aerospace applications. Rather than provide gaseous containment and pressure containment using a same sealing structure, systems described herein may separately contain the gases within an inner gaseous boundary and maintain a pressure or vacuum within an outer pressure boundary.

To provide the inner gaseous boundary, the system includes an inner retort assembly within an outer pressure boundary provided by an outer vessel housing. Due to the containment of the inner retort assembly within the pressure boundary, a pressure differential across the inner retort assembly may be low or negligible, such that the inner retort assembly may experience low mechanical loads. As a result, the inner retort assembly may be manufactured with materials selected for properties other than structural properties (e.g., thermal stability, chemical compatibility, corrosion resistance, manufacturability, or cost), such as lightweight, thermally stable ceramic materials.

Additionally, flow into or out of retort assembly may be subject to relatively low mass transfer rates driven primarily by concentration gradients of the gases within the retort assembly and other gases outside the retort assembly (causing diffusive flow), rather than an absolute pressure differential (causing bulk flow), such that the inner retort assembly may be sealed without the use of additional, low temperature capable sealing structures, and hermiticity is not a requirement. For example, the retort chamber and the retort lid may be sealed against each other using a contact seal formed by surfaces of the retort chamber and lid. The lack of gasket or other removable sealing materials may enable the retort assembly, including the contact seal, to be positioned within one or more layers of insulation at a relatively high temperature, thereby reducing an amount of power to maintain the temperature within the retort assembly. In these various ways, thermal process systems described herein may have reduced weight and volume, reduced power consumption, and increased reliability compared to thermal process systems that do not separately form pressure and containment boundaries.

In some examples, the disclosure describes a thermal process system that includes a retort assembly, a heating assembly, and a vessel housing. The retort assembly includes a retort chamber and is configured to substantially contain one or more gases, such as reactants, in the retort chamber during a thermal process, such as a reaction. The heating assembly includes one or more heating elements and is configured to heat the retort chamber. The vessel housing is positioned around the retort chamber and the one or more heating elements and configured to maintain a pressure within the retort chamber.

In some examples, the disclosure describes a system for generating hydrogen gas from pyrolysis of a hydrocarbon. The system includes a pyrolysis reactor that includes a retort assembly, a heating assembly, and a vessel housing. The retort assembly includes a retort chamber and is configured to substantially contain the hydrocarbon and the hydrogen gas in the retort chamber during the pyrolysis and house one or more fibrous substrates defining a deposition surface for carbon generated from the pyrolysis. The heating assembly includes one or more heating elements and is configured to heat the retort chamber. The vessel housing is positioned around the retort chamber and the one or more heating elements and is configured to maintain a pressure within the retort chamber.

In some examples, the disclosure describes a method that includes receiving, by a retort assembly of a thermal process system, one or more gases and reacting, by the thermal process system, the one or more gases by maintaining reactor conditions. These reactor conditions include maintaining a temperature of a retort volume within the retort chamber above about 850° C., maintaining a pressure boundary between a reactor volume within a vessel housing and an environment external to the vessel housing, and maintaining a concentration or partial pressure boundary of the one or more gases within the retort volume, in which an absolute pressure within the retort volume and a pressure within the reactor volume are substantially the same.

The details of one or more examples are set forth in the accompanying drawings and the description below. Other features, objects, and advantages will be apparent from the description and drawings, and from the claims.

### BRIEF DESCRIPTION OF THE FIGURES

The details of one or more examples are set forth in the accompanying drawings and the description below. Other features, objects, and advantages will be apparent from the description and drawings, and from the claims.

FIG. 1A is a schematic block diagram illustrating an example system for generating oxygen from carbon dioxide.

FIG. 1B is a flowchart of an example technique for generating oxygen from carbon dioxide.

FIG. 2A is a schematic block diagram illustrating an example thermal process system.

FIG. 2B is a cross-sectional side view diagram illustrating an example thermal process system for generating hydrogen gas from hydrocarbons.

FIG. 3A is a flowchart of an example technique for reacting gases.

FIG. 3B is a flowchart of an example technique for pyrolyzing hydrocarbons.

FIG. 3C is a flowchart of an example technique for replacing substrates in a thermal process system.

FIG. 4A is an axially cross-sectional side view diagram illustrating an example pyrolysis reactor.

FIG. 4B is an axially cross-sectional perspective view diagram of the example pyrolysis reactor of FIG. 4A.

FIG. 4C is a radially cross-sectional perspective view diagram of the example pyrolysis reactor of FIG. 4A.

FIGS. 5A-5D are cross-sectional side view diagrams of example flow paths through a retort chamber.

### DETAILED DESCRIPTION

In general, the disclosure describes thermal process systems for maintaining high temperature and pressurized or vacuum conditions using relatively low power and low weight materials. In some instances, thermal process systems described herein may be utilized in aerospace applications, such as spacecraft. For example, a spacecraft may include a resource-limited and weight- and volume-sensitive environment for which resources like oxygen and water may be preserved in closed loop processes. The thermal process systems described herein may be used for various high temperature processes intended to preserve resources within this environment, such as a pyrolysis reactor for methane pyrolysis.

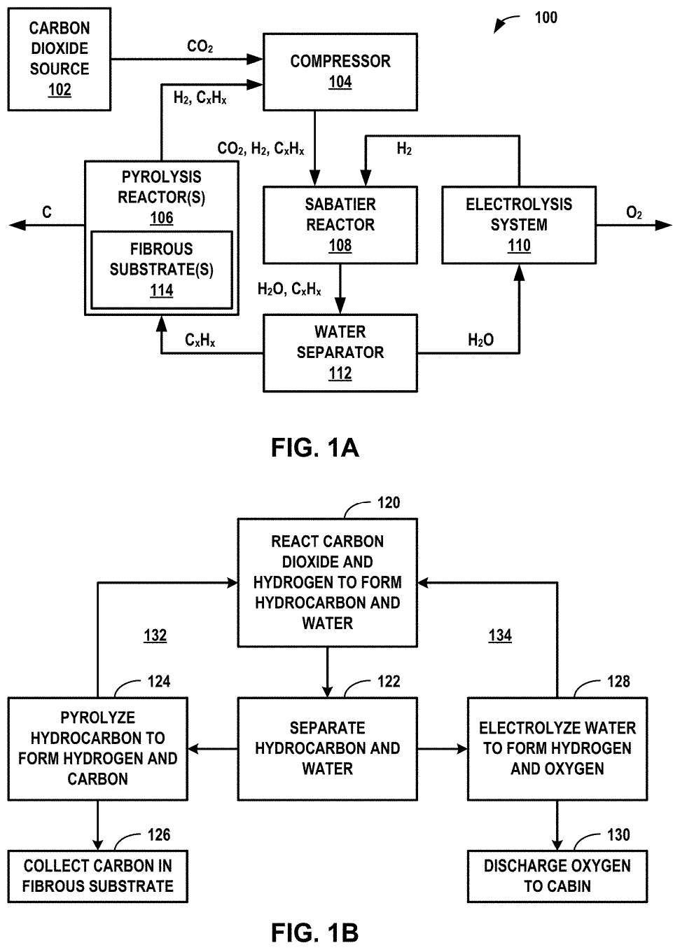

FIG. 1A is a schematic block diagram illustrating an example system 100 for generating oxygen from carbon dioxide produced in a spacecraft. While thermal process systems will be described with respect to one or more pyrolysis reactors 106 of system 100, the thermal systems described herein may be used with a variety of thermal processes involving high temperature, pressurized/vacuum process conditions for power, volume, and/or weight sensitive applications.

System 100 may include a carbon dioxide source 102. Carbon dioxide source 102 may be configured to receive carbon dioxide from an environment, such as a spacecraft cabin, concentrate the carbon dioxide for use as a recoverable oxygen source, and discharge purified air back to the spacecraft cabin. For example, carbon dioxide source 102 may include a carbon dioxide removal assembly (CDRA) or other carbon dioxide separation system.

System 100 may include a compressor 104. Compressor 104 may be configured to receive gases from various sources, such as carbon dioxide source 102 and one or more pyrolysis reactors 106, and compress the gases to an operating pressure of a Sabatier reactor 108. For example, Sabatier reactor 108 may operate at relatively higher pressures than carbon dioxide source 102 or pyrolysis reactors 106. In some examples, compressor 104 may be configured to create and maintain a vacuum in pyrolysis reactors 106.

System 100 may include a system for using hydrogen gas, such as Sabatier reactor 108. Sabatier reactor 108 may be configured to receive hydrogen gas, carbon dioxide, and optionally other hydrocarbon gasses, and generate water and hydrocarbons, such as methane and ethane. For example, Sabatier reactor 108 may be configured to receive hydrogen gas from pyrolysis reactors 106 and an electrolysis system 110, and carbon dioxide from carbon dioxide source 102, as well as other hydrocarbon gases, such as unreacted saturated hydrocarbons or byproduct unsaturated hydrocarbons from pyrolysis reactors 106. Sabatier reactor 108 may be configured to operate at a relatively moderate temperature and pressure, such as about 400° C. and about 100 kPa, and may include a catalyst or other rate-enhancing material or structure. Sabatier reactor 108 may be configured to operate according to the following exothermic reaction:

CO₂(g)+4H₂(g)→CH₄(g)+2H₂O(g)

System 100 may include a water separator 112 downstream of Sabatier reactor 108. Water separator 112 may be configured to receive water and hydrocarbons, such as methane and ethane, from Sabatier reactor 108 and separate the water from the hydrocarbons. Water separator 112 may be configured to discharge at least a portion of the water to electrolysis system 110 and at least a portion of the hydrocarbons to pyrolysis reactors 106. In some instances, a water discharged to pyrolysis reactors 106 may be substantially low (e.g., less than 1 vol. %). A variety of water separators may be used including, but not limited to, condensers, centrifugal separators, membranes (e.g., zeolite membranes), and the like.

As one hydrogen source for Sabatier reactor 108, system 100 may include an oxygen generation assembly, such as electrolysis system 110. Electrolysis system 110 may be configured to receive water from various sources, such as Sabatier reactor 108 or a potable water source and generate oxygen gas and hydrogen gas from the water. Electrolysis system 110 may be configured to discharge the hydrogen gas back to Sabatier reactor 108 and discharge oxygen gas to a storage or pressurization system for use in one or more environments. Electrolysis system 110 may be configured to operate according to the following reaction:

2H₂O(g/l)→2H₂(g)+O₂(g)

As described above, water separator 112 may be configured to discharge hydrocarbons generated from Sabatier reactor 108 to one or more pyrolysis reactors 106. System 100 may be configured to preserve at least a portion of the hydrogen present in hydrocarbons from Sabatier reactor 108 by sending the hydrocarbons through one or more pyrolysis reactors 106 to produce hydrogen gas.

Pyrolysis reactor(s) 106 may each be configured to generate hydrogen gas from hydrocarbons through pyrolysis. In the example of FIG. 1, pyrolysis reactors 106 may be configured to generate hydrogen gas and carbon from methane, such as according to the following endothermic reaction:

CH₄(g)→2H₂(g)+C(s)

Each pyrolysis reactor 106 may include one or more fibrous substrates 114. Each fibrous substrate 114 may be configured to provide a deposition surface for carbon generated from the pyrolysis of the hydrocarbons. In some examples, fibrous substrates 114 may be configured to be removable from pyrolysis reactors 106 once spent and replaced with a new fibrous substrate 114.

As will be explained further below, pyrolysis reactor 106 may be configured with separate pressure and gas containment boundaries, such that pyrolysis reactors 106 may operate with lower power and/or have lower weight and/or volume. For example, an outer vessel housing may maintain a pressurized or vacuum environment, and an inner retort assembly positioned, heated, and insulated within the outer vessel housing may contain the gases at high temperature. As a result, pyrolysis reactor 106 may be operated at temperature and pressure conditions that enable high recovery of carbon with reduced power input.

FIG. 1B is a flowchart of an example technique for generating oxygen from carbon dioxide. The example technique of FIG. 1B will be described with reference to system 100 of FIG. 1A; however, the example technique of FIG. 1B may be performed by other systems. The technique of FIG. 1B includes a carbon recovery cycle 132 and an oxygen recovery cycle 134. While carbon recovery cycle 132 and oxygen recovery cycle 134 will be referred to as separate cycles based on discharged products, it will be understood that hydrogen may be recovered in both cycles 132 and 134, and that recovery of hydrogen in both cycles may enable more complete recovery of oxygen and/or carbon in cycles 134 and 132, respectively.

In both carbon recovery cycle 132 and oxygen recovery cycle 134, Sabatier reactor 108 may react carbon dioxide and hydrogen to form one or more hydrocarbons and water (120). For example, Sabatier reactor 108 may receive carbon dioxide from carbon dioxide source 102 and hydrogen gas and, optionally, hydrocarbons from pyrolysis reactors 106 via compressor 104. Sabatier reactor 108 may react the carbon dioxide and hydrogen gas under operating conditions, such as about 400° C. and about 100 kPa. Sabatier reactor 108 may discharge water and hydrocarbons, such as methane and ethane, to water separator 112.

Water separator 112 may separate hydrocarbons and water (122). For example, water separator 112 may receive hydrocarbons and water from Sabatier reactor 108 and use one or more phase change, filtration, or other separation processes to separate hydrocarbons and water. Water separator 112 may discharge at least a portion of the hydrocarbons to pyrolysis reactors 106 and at least a portion of the water to electrolysis system 128. In some examples, the stream discharged to pyrolysis reactors 106 includes less than 1 vol. % water.

In oxygen recovery cycle 134, electrolysis system 128 may electrolyze water to hydrogen and oxygen (128). For example, electrolysis system 128 may receive water from Sabatier reactor 108 via water separator 112, and optionally other water sources such as dehumidification systems. Electrolysis system 128 may discharge hydrogen gas back to Sabatier reactor 108 to further react with carbon dioxide (120). In some examples, the hydrogen gas generated from electrolysis system 128 may account for about half (e.g., between about 40% and about 60%) of the hydrogen gas reacted in Sabatier reactor 108. Electrolysis system 128 may discharge oxygen to a cabin (130) or storage system to complete recovery of the oxygen received as carbon dioxide.

In carbon recovery cycle 132, pyrolysis reactors 106 may pyrolyze hydrocarbons to form hydrogen and carbon (124). For example, pyrolysis reactors 106 may receive hydrocarbons from Sabatier reactor 108 via water separator 112 and pyrolyze the hydrocarbons under pyrolysis operating conditions, such as a temperature between about 850° C. and about 1300° C., and preferably between about 1050° C. and about 1200° C., and a pressure between about 1 kPa and about 65 kPa, and preferably between about 7 kPa and about 30 kPa, to form hydrogen gas and carbon. Pyrolysis reactors 106 may discharge hydrogen gas, and optionally unreacted or partially reacted hydrocarbons, to Sabatier reactor 108 to further react with carbon dioxide (120). Pyrolysis reactors 106 may capture the carbon in fibrous substrates 106 (126), which may be removed from pyrolysis reactors 106 at an end of an operating life (e.g., initiation of soot formation), replaced, and stored.

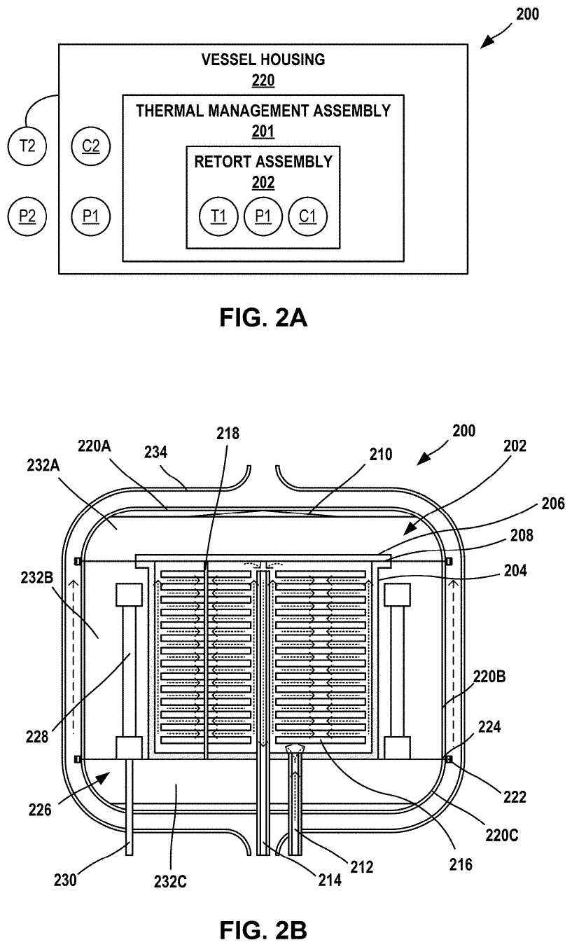

As will be described herein, thermal process systems, such as pyrolysis reactors 106 of FIG. 1A, may be configured to operate with reduced power by maintaining a high temperature process volume enabled by separation of an inner containment boundary within an outer pressure boundary separated by insulation. FIG. 2A is a schematic block diagram illustrating an example thermal process system 200. Thermal process system 200 may be configured to maintain thermal process conditions that include a relatively high process temperature T1 and a process pressure or vacuum P1, and to contain various gases having gas concentrations C1. Thermal process system 200 may be used for a variety of high temperature (e.g., >400° C., or higher than a thermal degradation temperature of gasket sealing materials) thermal processes that may involve a pressure differential including, but not limited to, reactions, such as methane pyrolysis, heating, inerting, and the like.

To maintain gas concentration C1, thermal process system 200 includes a retort assembly 202 configured to provide a retort volume for processing one or more gases. Retort assembly 202 is configured to form a concentration or partial pressure boundary for the one or more gases in a retort chamber to substantially contain the one or more gases during a thermal process. To reduce thermal losses from thermal process system 200, a seal defining the concentration and/or partial pressure boundary of the one or more gases may be preferably in a high temperature region of thermal process system 200, such as part of retort assembly 202. For example, in a pyrolysis reaction, a seal forming the concentration and/or partial pressure boundary may be configured to withstand temperatures of greater than 850° C., while a seal forming a pressure boundary may be configured to be both hermetic and reusable. However, high pressure differential seals, such as washers or O-rings formed from polymeric materials, may not be capable of withstanding more than a few hundred degrees Celsius, and high temperature seals, such as malleable seals formed from metallic materials, may not be capable of reuse.

To enable high temperature operation of retort assembly 202, hermetic sealing of gases within reaction system 200, and substantial containment of gases within retort assembly 202, thermal process system 200 is configured to separate the hermetic, pressure boundary characteristic for maintaining a pressure within reaction system 200 from the gas containment boundary characteristic for sealing the gases within retort assembly 202. By providing these gas containment and pressure containment functions using separate structures and positioning the gas containment within the pressure containment, retort assembly 202 may be capable of containing gases at high temperatures (e.g., greater than 400° C.) and limiting gaseous exchanges inside reaction system 200 without forming a hermetic seal.

To maintain process pressure P1, thermal process system 200 includes a vessel housing 220 configured to provide a pressurized (e.g., pressure above or below ambient pressure), hermetically-sealed environment for processing one or more gases. Vessel housing 220 is configured to form a pressure boundary for gases in thermal process system 200 and reduce a pressure differential across retort assembly 202 by maintaining a pressure or vacuum within vessel housing 220, including within retort assembly 202 positioned within vessel housing 220. Vessel housing 220 may be at a relatively low temperature T2 due to heat containment provided by thermal management assembly 201, such that a variety of reusable sealing mechanisms may be used to provide a hermetic seal between an external pressure P2 and the reaction pressure P1, such as O-rings.

Vessel housing 220 is positioned around retort assembly 202 and thermal management assembly 201. As a result, retort assembly 202 is subject to a reduced or negligible pressure difference between a retort volume within retort assembly 202 and a vessel volume outside retort assembly 202. Due to the reduced or negligible pressure difference across retort assembly 202, the concentration or partial pressure boundary may be maintained using sealing mechanisms configured to seal gases driven primarily by a concentration gradient (C1-C2). These sealing mechanisms may be more resistant to heat than polymer-based sealing mechanisms, enabling retort assembly 202, and correspondingly the sealing mechanism, to be positioned within and operated at a high temperature.

To maintain reaction temperature T1, thermal process system 200 includes a thermal management assembly 201 configured to maintain a high temperature environment within retort assembly 202. As will be described below, thermal management assembly 201 may include a heating assembly configured to heat retort assembly 202 and insulative and/or reflective materials configured to reduce heat transfer from retort assembly 202. As a result, thermal management assembly 201 may consume relatively low amounts of power to maintain the thermal process conditions within retort assembly 202.

FIG. 2B is a cross-sectional side view diagram illustrating an example thermal process system 200 for generating hydrogen gas from hydrocarbons, such as may be used for pyrolysis reactors 106 of FIG. 1A. However, in other examples, thermal process system 200 may be used for reactions other than methane pyrolysis that proceed at high temperatures and pressure or vacuum environments.

Thermal process system 200 includes a retort assembly 202. In the example of FIG. 2A, retort assembly 202 includes a retort chamber 204 and a removable retort lid 206. Retort assembly 202 is configured to substantially contain one or more gases in retort chamber 204 during a reaction. For example, retort chamber 204 and retort lid 206 may define a reaction volume in which one or more gases undergo a reaction. Retort chamber 204 and retort lid 206 may have a variety of shapes. In the example of FIG. 2A, retort assembly 202 may be configured for general flow along an axis of retort chamber 204, such that gases, such as hydrocarbon gases, may be continuously received and product gases, such as hydrogen gas, reaction byproducts, and unreacted hydrocarbon gases, may be continuously discharged from thermal process system 200. Retort chamber 204 may be sized to have a particular residence time and pressure drop for a particular flow rate of gases and particular void fraction of one or more fibrous substrates 216.

During a thermal process, such as a reaction, heating, or inerting process, the retort volume within retort chamber 204 may be at relatively high temperatures. For example, the reaction volume may have a temperature greater than about 850° C. As such, retort chamber 204 and retort lid 206 may be configured for exposure to relatively high temperatures. In some examples, each of retort lid 206 and retort chamber 204 includes non-metallic materials, such as graphite, a ceramic, or a ceramic matrix composite. Non-metallic materials may be stronger and more resistant to creep, corrosion, instabilities, or other high temperature structural defects than metals. In some examples, a surface of retort chamber 204 and retort lid 206 may include a ceramic coating or other coating compatible with particular gases contained within retort chamber 204, such as an antioxidant coating described in U.S. patent application Ser. No. 17/303,643, entitled “HIGH TEMPERATURE METAL CARBIDE COATINGS” and filed Jun. 3, 2021, incorporated herein by reference in its entirety. Further, retort assembly 202 may experience a relatively low pressure differential due to the equalizing pressure between the internal retort pressure and the external volume provided by vessel housing 220, a mechanical load on retort chamber 204 may be relatively small. As such, provided acceptable high-temperature strength and toughness, the properties of interest for materials of retort chamber 204 and retort lid 206 may include, but are not limited to: reduced density, such as to reduce weight; increased chemical compatibility with gases, such as methane and hydrogen, at high temperatures; thermal stability; thermal conductivity; hardness, such as to increase robustness and/or dimensional stability; manufacturability; and the like.

In some examples, a material of retort chamber 204 and retort lid 206 may include graphite. Graphite has excellent high-temperature capabilities, including stability up to 2700° C., has excellent thermal shock properties, has low density, is chemically inert in a methane/hydrogen environment, and is easily machinable. While graphite has a lower strength than other advanced ceramics, retort chamber 204 and retort lid 206 may be subject to relatively low mechanical loads. To improve the hardness of the graphite, an in-situ reaction layer of SiC can be applied, which may improve the robustness of portions of retort assembly 202 that may be frequently accessed. In some examples, a material of retort chamber 204 and retort lid 206 may include a ceramic such as silicon carbide (SiC) or silicon nitride (Si₃N₄), or a ceramic matrix composite, such as SiC/SiC or carbon/carbon composite.

As described in FIG. 2A above, retort assembly 202 is configured to form a concentration or partial pressure boundary for the one or more gases in retort chamber 204. Once positioned, retort chamber 204 and retort lid 206 may be configured to contain the one or more gases and substantially prevent the process gases from migrating from the retort volume into another volume, or other gases from migrating into the retort volume. Retort lid 206 is configured to contact a wall of retort chamber 204 at a sealing interface 208 to form a contact seal. For example, a surface of each of retort lid 206 and retort chamber 204 at sealing interface 208 may have a relatively low roughness. Thermal process system 200 may include a preload assembly 210 configured to directly or indirectly exert force on retort lid 206, such as to maintain a position of retort lid 206 with respect to retort chamber 204. For example, preload assembly 210 may include a spring that applies a prescribed clamp load to retort lid 206 and retort chamber 204 (transferred via insulation 232) to inhibit gas migration across sealing interface 208. Sealing interface 208 may be configured to substantially contain the gases within retort chamber 204 for concentration differentials and small pressure differentials across retort chamber 204. For example, since the concentrations of gas phases inside and outside retort chamber may be different, diffusive flow driven by concentration or partial pressure differences may occur. In some examples, a width of a gap at sealing interface 208 between retort chamber 204 and retort lid 206 may be reduced, such as by ensuring both contact surfaces of retort chamber 204 and retort lid 206 are smooth, and that a surface area of contact is increased.

Thermal process system 200 includes one or more inlets 212 for discharging an inlet gas mixture into retort chamber 204 and one or more outlets 214 for receiving an outlet gas mixture from retort chamber 204. Inlet 212 and outlet 214 may be configured to at least partially control flow through retort chamber 214. In some examples, inlet 212 and outlet 214 may be configured to define flow of gases from inlet 212 to outlet 214, such that the gases substantially flow through retort chamber 204 and any structures, such as substrates 216, within retort chamber 204. In the example of FIG. 2B, inlet 212 includes an opening at a first end of retort chamber 204 for discharging the inlet gas mixture into retort chamber 204, while outlet 214 includes an opening at a second, opposite end for receiving gases from retort chamber 204. As a result, gases may flow from inlet 212 through the retort volume within retort chamber 204, including substrate 216, and to outlet 214. However, both inlet 212 and outlet 214 may physically enter retort chamber 204 through a same end opposite retort lid 206, such that retort lid 206 may be easily accessed and removed for replacement of substrates 216.

Retort assembly 202 is configured to house one or more substrates 216 within retort chamber 204 in a spatial arrangement defining channels between and around substrates 216. Each substrate 216 may include a plurality of fibers. Fibers may be configured to operate under operating conditions for pyrolysis of hydrocarbons and may have a relatively high melting or thermal degradation temperature, so as to maintain structural stability throughout the entire range of possible pyrolysis temperatures, or may have a relatively low material density to reduce a weight of fibrous substrates 216. In some examples, the plurality of fibers may be configured and arranged to remove carbon with reduced soot formation. For example, to increase deposition of carbon and reduce formation of soot, substrates 216 may be configured to provide a sufficiently high surface area for a particular volume of gas, such that intermediates of pyrolyzed hydrocarbons favor surface reactions on the fibers of substrates 216. A variety of materials may be used for fibers including, but not limited to, carbon, zirconium dioxide (zirconia), silicon dioxide (silica), and the like.

While retort chamber 204 is illustrated as including substrates 216 having a stacked arrangement in series and a puck shape, substrates 216 may include any arrangement, including elongated shape or parallel arrangement. An interior volume of retort chamber 204 may be accessible such that substrates 216 may be removed and replaced as needed. In some examples, pyrolysis reactor 200 may include one or more structures 218 between and/or around substrates 204 that are configured to position substrates 216 in a spatial arrangement. Structures 218 may be configured to position fibrous substrates 216 and/or provide support to substrates 216.

Reactor inlet 212 and reactor outlet 214, together with a spatial arrangement of substrates 216, may be configured to define flow of the gas mixtures through channels between substrates 216. Gas may flow from an opening of inlet 212 at the first end into retort chamber 204, around and between substrates 216, and through an opening of outlet 214 at a second end from retort chamber 204. In some examples, at least one of reactor inlet 212 or reactor outlet 214 is aligned with the axis of retort chamber 204, while the other of reactor inlet 212 or reactor outlet 214 is positioned radially outward from the axis.

Thermal process system 200 includes a vessel housing 220A, 220B, 220C (referred to collectively as “vessel housing 220”). Vessel housing 220 is positioned around retort chamber 204 and one or more heating elements 228. Vessel housing 220 is configured to maintain a pressure within retort chamber 204 by forming a pressure boundary for one or more gases in retort chamber 204. Materials used for vessel housing 220 may be selected for relatively low weight, such as aluminum. In some examples, vessel housing 220 includes one or more thin compliant layers configured to compensate for differential thermal growth and manufacturing tolerances.

In some examples, vessel housing 220 may be configured in two or more sections to at least partially disassemble to access one or more components within vessel housing 220. In the example of FIG. 2A, vessel housing 220 includes a top end cap 220A, a body 220B, and a bottom end cap 220C. Top end cap 220A and bottom end cap 220C may be configured to be detached from a remainder of vessel housing 220, such as body 220B. For example, top end cap 220A may be detached from body 220B to access contents of retort assembly 202, such as substrates 216 via removal of retort lid 206, while bottom end cap 220C may be detached from body 220B to access components of heating assembly 226, such as heating elements 228, or retort assembly 202, such as inlet 212 and/or outlet 214. Adjacent sections of vessel housing 220 may be attached using one or more connectors 222 and hermetically sealed against each other using one or more seals 224 positioned at an interface between adjacent sections of vessel housing 220. For example, connectors 222 may include bolts or other fasteners, and seals 224 may include one or more O-rings.

Thermal process system 200 includes a heating assembly 226 configured to heat retort chamber 204. Heating assembly 226 includes one or more heating elements 228 positioned around retort chamber 204. A variety of heating mechanisms may be used for heating elements 228 including, but not limited to: external or internal resistive heating elements, such as ceramic resistive heater rods; induction heating elements, contact heating elements for resistively heating substrates 216, and the like. Electrical connections 230 for heating assembly 226 may be positioned opposite retort lid 206 or through other interfaces that may not interfere with removal of lid 206 from retort chamber 204.

In some examples, reaction system 200 includes thermal retention materials surrounding retort chamber 204 and/or retort lid 206 configured to retain heat within retort chamber 204. In some examples, reaction system 200 may include insulation materials configured to reduce thermal conductive losses from retort chamber 204. In the example of FIG. 2B, reaction system 200 includes insulation 232A, 232B, 232C (referred to collectively as “insulation 232”) surrounding retort chamber 204 and heating elements 228. In some examples, insulation 232 includes solid insulation material, such as a solid microporous ceramic insulation material capable of working temperatures up to about 1200° C. In addition to providing insulative properties, solid insulation material may be used as a structural support for retort chamber 204 and retort lid 206 by securely positioning retort chamber 204 and retort lid 206 within vessel housing 220 and, in some instances, transferring a force from preload assembly 210 to maintain a tight seal at sealing interface 208 between retort chamber 204 and retort lid 206. In some examples, as an alternative or in addition to insulation materials, reaction system 200 may include heat shields configured to reduce thermal radiative losses from retort chamber 204. For example, one or more metallic heat shields may be positioned around at least a portion of retort chamber 204 and/or retort lid 206 to reflect radiation back to retort chamber 204 and/or retort lid 206, such as on an inner surface of insulation 232.

In some examples, insulation material 232 may include one or more sections configured to be removed to provide access to various components within vessel housing 220. In the example of FIG. 2B, insulation material 232 includes a top portion 232A configured to be removed from vessel housing 220 to access retort lid 206. For example, once substrates 216 are loaded with a reaction product, such as carbon, top end cap 220A may be removed, top portion 232A may be removed, and retort lid 206 may be removed to access substrates 216 without disturbing other components or connections to thermal process system 200, such as plumbing to retort chamber 204, heating elements 228 or connections to heating elements 228, or other portions of insulation 232. In the example of FIG. 2B, insulation material 232 also includes a bottom portion 232C configured to be removed from vessel housing 220 to access components around or near a bottom of retort chamber 204, such as heating elements 228, inlet 212, or outlet 214, without accessing retort lid 206. For example, to service heating elements 228, bottom end cap 220C may be removed and bottom portion 232C may be removed to access heating elements 228 without disturbing a fit of retort chamber 204 with respect to insulation 232 and vessel housing 220.

In addition to thermal management structures, such as heating assembly 226 and insulation material 232, positioned within vessel housing 220, thermal process system 200 may include one or more thermal management structures outside vessel housing 220. In the example of FIG. 2B, reaction system 200 includes a cooling duct 234 positioned around at least a portion of vessel housing 220. Cooling duct 234 is configured to flow cooling air across an outer surface of vessel housing 220. For example, insulative material 232 may be configured to maintain an outer surface of vessel housing 220 at a first temperature, such as about 100° C., while cooling duct 234 may be configured to maintain an outer surface of cooling duct 234 exposed to an environment at a second, lower temperature, such as about 50° C. A variety of materials may be used for cooling duct 234 including, but not limited to, aluminum.

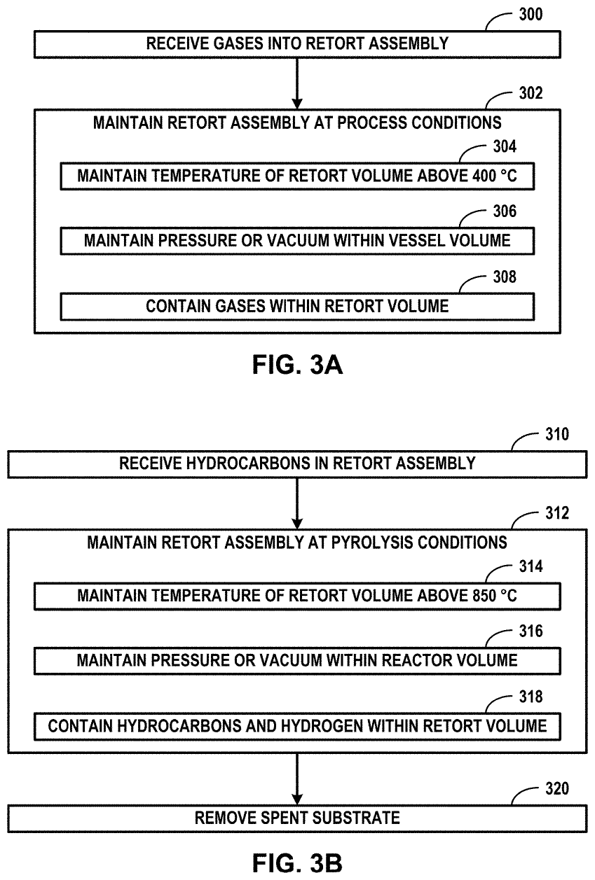

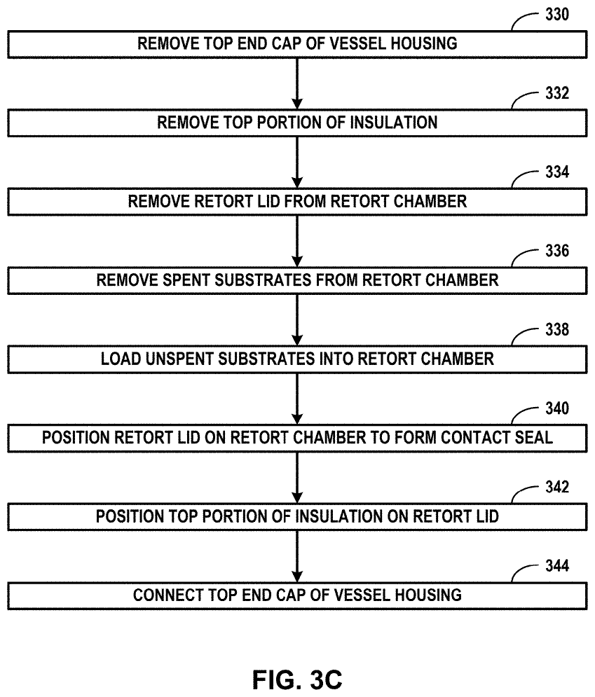

FIG. 3A is a flowchart of an example technique for reacting gases. Reference will be made to thermal process system 200 of FIG. 2B; however, other thermal process systems may be used to perform the technique of FIG. 3A. The method includes receiving gases into retort chamber 204 (300). The method includes maintaining a retort volume within retort chamber 204 at thermal process conditions (302). For example, a controller may operate heating elements 228 to maintain a temperature of the retort volume within retort chamber 204 above a threshold temperature, such as about 400° C. (304), which may be substantially higher than conventional seals, but within an operating range of a contact seal formed by retort chamber 204 and retort lid 206. Due to the position of retort chamber 204 within insulation 232, a relatively low amount of power may be used to maintain the temperature of the retort volume. The controller may control a pressure or vacuum of gas streams received by inlet 212 and/or discharged by outlet 214. Vessel housing 220 may maintain the pressure within the reactor volume (306), such that a pressure within retort chamber 204 is substantially equal to a pressure outside retort chamber 204, but within vessel housing 220. Retort chamber 204 and retort lid 206 may seal against each other due to the substantially equal pressure to contain gases within the retort volume (308).

FIG. 3B is a flowchart of an example technique for pyrolyzing hydrocarbons. Reference will be made to thermal process system 200 of FIG. 2B; however, other thermal process systems may be used to perform the technique of FIG. 3B. The method includes receiving gases into retort chamber 204 (310). The method includes maintaining a retort volume within retort chamber 204 at pyrolysis conditions (312), such that methane is consumed to form hydrogen gas and carbon. For example, a controller may operate heating elements 228 to maintain a temperature of the retort volume within retort chamber 204 above a threshold temperature, such as about 850° C. (314). The controller may control a vacuum of methane and/or hydrogen gas streams received by inlet 212 and/or discharged by outlet 214. Vessel housing 220 may maintain the pressure or vacuum within the reactor volume (316), such that a pressure within retort chamber 204 is substantially equal to a pressure outside retort chamber 204, but within vessel housing 220. Retort chamber 204 and retort lid 206 may seal against each other due to the substantially equal pressure to contain methane and hydrogen gas within the retort volume (318). Once the carbon has substantially loaded substrate 216, substrates 216 may be removed from retort chamber 204 (320). For example, top end cap 220A may be removed, top portion 232A may be removed, and retort lid 206 may be removed to access substrates 216.

Thermal process systems described herein may be configured for relatively easy disassembly. For example, as described above with respect to thermal process system 200 of FIG. 2B, substrates 216 may be configured to reduce an amount of soot formation during hydrocarbon pyrolysis, and may be easily removed once spent. FIG. 3C is a flowchart of an example technique for replacing substrates in a thermal process system. Reference will be made to thermal process system 200 of FIG. 2B; however, other thermal process systems may be used to perform the technique of FIG. 3C. The method may include removing top end cap 220A to release pressure from preload assembly 210 and open a vessel volume of vessel housing 220 (330). Once top end cap 220A is removed, top portion 232A of insulation 232 may be removed to access retort lid 206 (332). Retort lid 206 may be removed to access contents of retort chamber 204 (334). Spend substrates 216 may be removed from retort chamber 204 (336). As described above, such substrates may be configured to reduce soot formation, such that very little soot may be present in retort chamber 204. Unspent substrates 216 may be loaded into retort chamber 204 (338). Retort lid 206 may be positioned on retort chamber 204 to form a contact seal at sealing interface 208, thereby providing a containment boundary for retort chamber 204 (340). Top portion 232A of insulation 232 may be positioned on retort lid 206 (342), and top end cap 220A may be connected to a remainder of vessel housing 220, including positioning any sealing mechanisms such as O-rings, to form a pressure boundary (344).

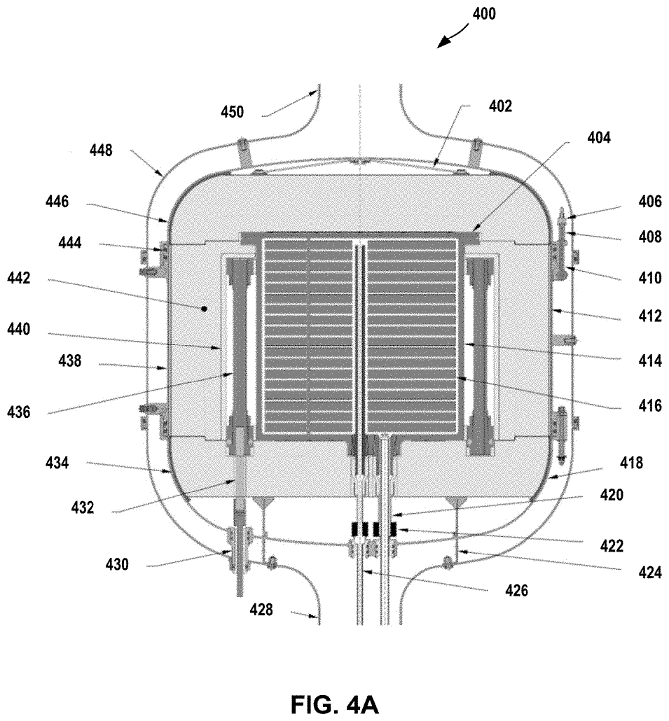

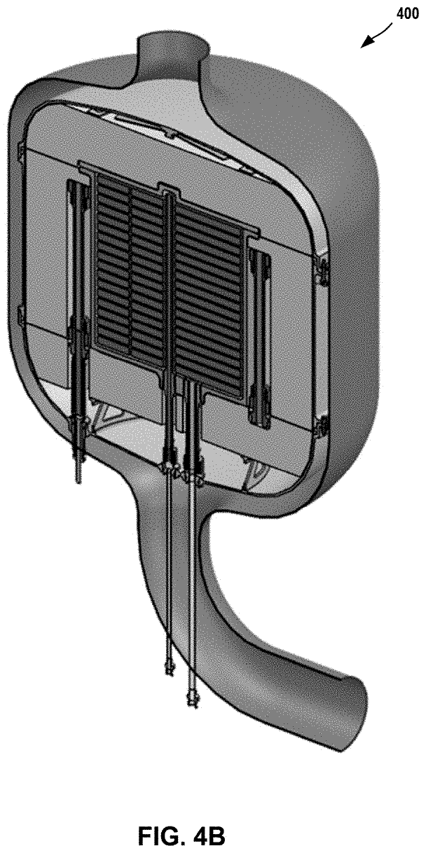

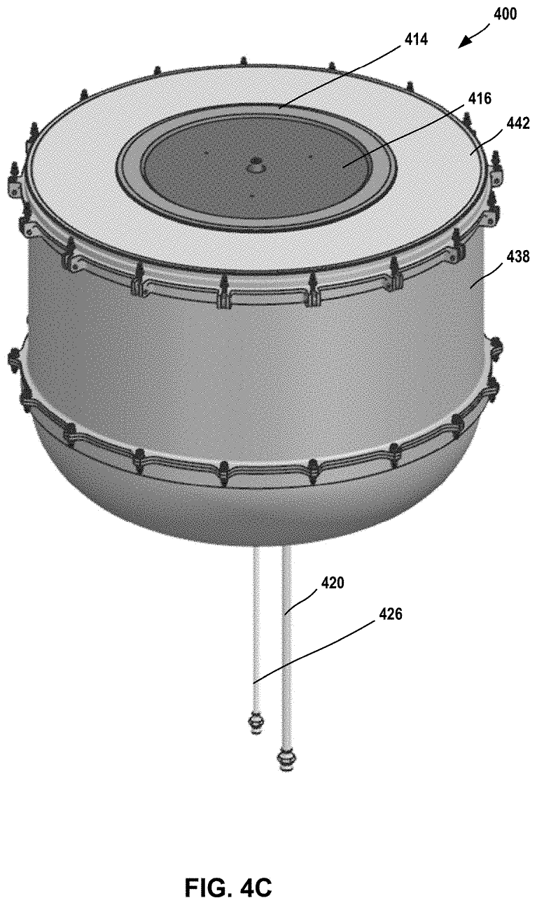

FIG. 4A is an axially cross-sectional side view diagram illustrating an example pyrolysis reactor 400. FIG. 4B is an axially cross-sectional perspective view diagram of the example pyrolysis reactor of FIG. 4A, and FIG. 4C is a radially cross-sectional perspective view diagram of the example pyrolysis reactor of FIG. 4A. Pyrolysis reactor 400 may be functionally and structurally similar to thermal process system 200 of FIGS. 2A and 2B.

Pyrolysis reactor 400 includes a retort 414 and retort lid 404 that define an interior reactor volume, such as a volume of about 5 liters (L) to about 15 L, and contain a stack of high-surface area substrates 416 which may be held at 1100-1200 C. Retort 414 and retort lid 404 may include a ceramic, such as graphite/SiC/SiC-SiC. A continuous feed of methane enters through a dual wall inlet tube 420 at one end, undergoing pyrolysis as the methane flows through the interior of retort 414. Carbon is deposited and captured on substrates 416, and hydrogen gas exists retort 414 through an outlet tube 426 that extends along the central axis of retort 414. This configuration places the methane inlet and the hydrogen outlet at opposite ends of the interior of retort 414 while keeping the connections for both on the bottom of retort 414. The service end of the reactor assembly is uncluttered, making weekly substrate replacement easier and increasing reliability of the system.

Retort 414 is encircled by a heater assembly that includes one or more heating elements 436, such as ceramic resistive heater rods, connected in series by arc-shaped ceramic bus bars. Heating elements 436 can be made from a wide variety of materials, including graphite, silicon carbide (SiC), or SiC/SiC composites, depending on the requirements of the unit. While other heater configurations and types may be used, such as resistive heating rods centrally located inside the retort, induction heating of the retort and substrates, and/or direct resistance heating of the substrates, external heating elements may provide the good combination of robustness, efficiency, repairability, and control system simplicity. Electrical connections for heating elements 428, such as power splice connector 432 and power feedthrough 430, are located opposite the service end of retort 414.

Surrounding retort 414 and heating elements 436 are multiple layers of insulation 442. The innermost layer is a relatively thin alumina felt 440, chosen due for its ability to withstand more than 1300° C. without experiencing degradation in properties. The remainder of insulation 442 is a solid microporous ceramic capable of working temperatures up to 1200° C. Solid microporous insulation may also be used as a structural support for retort 414, securely locating it, as well as transferring clamp load from a Breville spring 402, to maintain a tight seal at the interface between retort 414 and retort lid 404. In other examples, multi-layered radiation shields rather than solid insulation may be used, such as to reduce a size of reactor 400.

Encapsulating insulation 442 is an aluminum vacuum housing 438 that functions as a vacuum vessel, as its interior is controlled to the same nominal pressure as the reaction pressure inside retort 414 in order to contain the reaction gases within retort 414. Housing 438 has domed lower end cap 418 and service end cap 446 bolted at either end that are sealed with double O-rings 444. Service end cap 446 has a built-in spring 402 that applies a prescribed clamp load to retort lid 404 and retort 414 (transferred via the solid insulation) to inhibit gas migration across the interface. Situated between housing 438 and insulation 442 is a thin compliant layer 412 and 434 that compensates for differential thermal growth and manufacturing tolerances. The vacuum housing 438 is enclosed within an aluminum duct 448 that receives air at a cooling air inlet 428, directs air across its outer surface for cooling, resulting in a suitably cool (e.g., about 50° C.) outer touch temperature for the reactor assembly during operation, and discharges cooling air at a cooling air outlet 450. Housing 438 and duct 448 may be further supported by a pressure drop screen 424. The reactor is designed for ease of regular service, as well as on-condition maintenance. Joints are fastened using captive wingnuts 406, swing bolts 410, and blow-off springs 408, allowing tool-less access no small loose parts. All joints may be sealed with radial-fit O-rings or an O-ring axial face seal, which may be effective regardless of assembler skill, and remain in place when joints are opened.

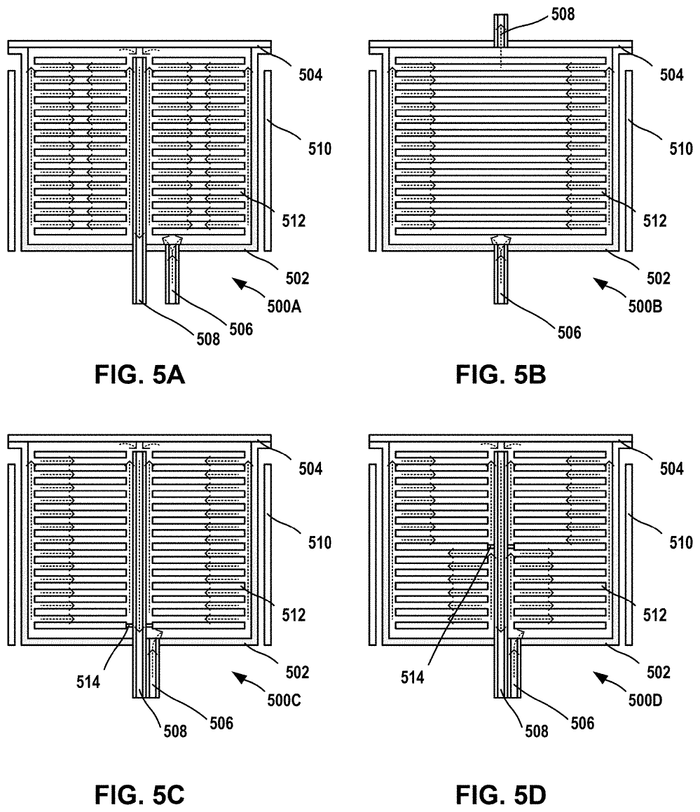

FIGS. 5A-5D are cross-sectional side view diagrams of example flow paths through a retort chamber of various retort assemblies 500. Each retort assembly 500A, 500B, 500C, 500D includes a retort chamber 502, retort lid 504, inlet 506, outlet 508, heating element 510, and substrates 512, and may be functionally similar to retort assembly 202, retort chamber 204, retort lid 206, inlet 212, outlet 214, heating elements 238, and substrates 216 of FIG. 2B.

Referring to FIG. 5A, retort assembly 500A may include outlet 508 positioned along an axis of retort chamber 502 and an inlet 506 positioned slightly off-axis, such that inlet 506 and outlet 508 may both be at or near the axis of retort chamber 502 to discharge or receive gas near a center of retort chamber 502. However, inlet 506 and outlet 508 may be sufficiently spaced to reduce heat transfer between inlet 506 and outlet 508 and reduce clogging. Gases may flow through a radially inward channel around outlet 508, a radially outward channel along a wall of retort chamber 502, and between substrates 512. Referring to FIG. 5B, retort assembly 500B may be configured for substantially plug flow, such that gases may flow from inlet 506 to outlet 508 through substrates 512 in a substantially axially uniform manner.

In some examples, retort assemblies may include one or more flow diverting features configured to radially divert flow through retort chamber 502. For example, diverting flow of gases may more evenly mix or heat gases, and may be suitable for thermal processes which have a reduced likelihood of in situ solid product formation (e.g., soot). Referring to FIGS. 5C and 5D, retort assemblies 500C and 500D may include one or more baffles 514 configured to modify a direction of flow of gases through retort chamber 502. In the example of FIG. 5C, baffle 514 is positioned at a beginning of flow, while in the example of FIG. 5D, baffle 514 is positioned at a mid-point of flow.

Example 1: A thermal process system includes a retort assembly comprising a retort chamber and configured to substantially contain one or more gases in the retort chamber during a thermal process; a heating assembly comprising one or more heating elements and configured to heat the retort chamber; and a vessel housing positioned around the retort chamber and the one or more heating elements and configured to maintain a pressure within the retort chamber.

Example 2: The thermal process system of example 1, wherein the retort assembly is configured to form a concentration or partial pressure boundary for the one or more gases in the retort chamber, and wherein the vessel housing is configured to form a pressure boundary between an interior volume of the vessel housing and an external environment.

Example 3: The thermal process system of any of examples 1 and 2, wherein the retort assembly further comprises a removable retort lid configured to contact a wall of the retort chamber at a sealing interface, and wherein the sealing interface between the retort lid and the retort chamber is configured to form a contact seal.

Example 4: The thermal process system of example 3, wherein the contact seal is non-hermetic and does not include a gasket.

Example 5: The thermal process system of any of examples 3 and 4, wherein each of the retort lid and the retort chamber comprises at least one of graphite, a ceramic, or a ceramic matrix composite.

Example 6: The thermal process system of example 5, wherein a surface of the retort lid and the retort chamber comprise a ceramic coating.

Example 7: The thermal process system of any of examples 3 through 6, further comprising insulation material defining an inner insulated region, wherein the contact seal is enclosed within the inner insulated region.

Example 8: The thermal process system of any of examples 3 through 7, wherein the vessel housing further comprises a preload assembly configured to directly or indirectly exert force on the retort lid.

Example 9: The thermal process system of any of examples 1 through 8, wherein the retort assembly further comprises: an inlet configured to discharge an inlet gas mixture into the retort chamber; and an outlet configured to receive an outlet gas mixture from the retort chamber.

Example 10: The thermal process system of example 9, wherein the inlet and the outlet are configured to define flow through the retort chamber from the inlet to the outlet.

Example 11: The thermal process system of any of examples 9 and 10, wherein the retort chamber defines an axis between a first end and a second end, opposite the first end, wherein an opening of the inlet is positioned at the first end, and wherein an opening of the outlet is positioned at the second end.

Example 12: The thermal process system of any of examples 9 through 11, wherein the retort chamber defines an axis between a first end and a second end, opposite the first end, wherein at least one of the inlet or the outlet is aligned with the axis, and wherein the other of the inlet or the outlet is positioned radially outward from the axis.

Example 13: The thermal process system of any of examples 9 through 12, wherein the retort assembly is configured to house one or more substrates within the retort chamber in a spatial arrangement defining channels between and around the one or more substrates, and wherein the inlet and the outlet are configured to define flow of the gas mixtures through the channels.

Example 14: The thermal process system of example 13, wherein the retort assembly further comprises a support structure configured to position the one or more substrates in the spatial arrangement.

Example 15: The thermal process system of any of examples 1 through 14, wherein the one or more heating elements are positioned around the retort chamber.

Example 16: The thermal process system of any of examples 1 through 15, wherein the one or more heating elements are positioned within the retort chamber.

Example 17: The thermal process system of any of examples 1 through 16, wherein the one or more heating elements comprise electrical contacts configured to deliver a current to the retort chamber to generate resistive heat in the retort chamber.

Example 18: The thermal process system of any of examples 1 through 17, wherein the one or more heating elements comprise electrical contacts configured to deliver a current to the one or more substrates in the retort chamber to generate resistive heat in the one or more substrates.

Example 19: The thermal process system of any of examples 1 through 18, wherein the one or more heating elements comprise at least one of graphite, a ceramic, or a ceramic matrix composite.

Example 20: The thermal process system of any of examples 1 through 19, further comprising insulation material surrounding the retort chamber.

Example 21: The thermal process system of example 20, wherein the insulation material comprises solid insulation material.

Example 22: The thermal process system of any of examples 20 and 21, wherein the retort assembly further comprises a removable retort lid, wherein the vessel housing comprises a top end cap configured to be detached from a remainder of the vessel housing, and wherein the insulation material comprises a top portion configured to be removed from the vessel housing to provide access to the retort lid.

Example 23: The thermal process system of example 22, wherein the vessel housing comprises a bottom end cap configured to be detached from a remainder of the vessel housing, and wherein the insulation material comprises a bottom portion configured to be removed from the vessel housing to access the one or more heating elements without accessing the retort lid.

Example 24: The thermal process system of any of examples 1 through 23, further comprising a radiative foil at least partially surrounding the retort chamber.

Example 25: The thermal process system of any of examples 1 through 24, further comprising a cooling duct positioned around at least a portion of the vessel housing and configured to flow cooling air across an outer surface of the vessel housing.

Example 26: A system of generating hydrogen gas includes a pyrolysis reactor configured to generate the hydrogen gas from a hydrocarbon through pyrolysis, wherein the pyrolysis reactor comprises: a retort assembly includes substantially contain the hydrocarbon and the hydrogen gas in the retort chamber during the pyrolysis; and house one or more fibrous substrates defining a deposition surface for carbon generated from the pyrolysis; a heating assembly comprising one or more heating elements and configured to heat the retort chamber; and a vessel housing positioned around the retort chamber and the one or more heating elements and configured to maintain a pressure within the retort chamber.

Example 27: The system of example 26, wherein the pyrolysis reactor is configured to maintain a temperature of the retort chamber greater than about 850° C. during pyrolysis, and wherein the vessel housing is configured to maintain a pressure of the retort chamber less than about 100 torr during pyrolysis.

Example 28: The system of any of examples 26 and 27, wherein the hydrocarbon is methane, wherein the pyrolysis reactor is configured to generate carbon and a first portion of hydrogen gas from the methane, and wherein the system further comprises: a Sabatier reactor configured to: receive the first portion of hydrogen gas from the pyrolysis reactor and a second portion of hydrogen gas from an oxygen generation system; generate the methane and water from carbon dioxide and the first and second portions of hydrogen gas; and discharge the methane to the pyrolysis reactor; and an oxygen generation system configured to: receive the water from the Sabatier reactor; generate oxygen and the second portion of hydrogen gas from the water; and discharge the second portion of hydrogen gas to the Sabatier reactor.

Example 29: A method includes receiving, by a retort assembly of a thermal process system, one or more gases; and maintaining, by the thermal process system, the one or more gases at thermal process conditions by at least: maintaining a temperature of the one or more gases in a retort volume within the retort chamber above about 400° C.; maintaining a pressure boundary between a vessel volume within a vessel housing and an environment external to the vessel housing, wherein the retort chamber is positioned within the vessel housing; and maintaining a concentration or partial pressure boundary of the one or more gases within the retort volume, wherein a pressure within the retort volume and a pressure within the vessel volume are substantially the same.

Example 30: The method of example 29, wherein maintaining the temperature of the one or more gases further comprises heating, by a heating assembly of the thermal process system, the retort chamber.

Example 31: A method for generating hydrogen gas includes receiving, by a pyrolysis reactor, a hydrocarbon; and pyrolyzing, by the pyrolysis reactor, the hydrocarbon to generate the hydrogen gas and carbon by at least: maintaining a temperature of a retort volume within the retort chamber above about 850° C.; maintaining a pressure boundary between a vessel volume within a vessel housing and an environment external to the vessel housing, wherein the retort chamber is positioned within the vessel housing; and maintaining a concentration or partial pressure boundary of the hydrocarbon and the hydrogen gas between the retort volume and the vessel volume, wherein a pressure within the retort volume and a pressure within the vessel volume are substantially the same.

Example 32: The method of example 31, further includes generating, by the pyrolysis reactor, hydrogen gas and carbon from methane; generating, by a Sabatier reactor, methane and water from carbon dioxide and the hydrogen gas from the pyrolysis reactor; discharging, by the Sabatier reactor, the methane to the methane pyrolysis reactor; generating, by an electrolysis system, oxygen gas and hydrogen gas from the water from the Sabatier reactor; and discharging, by the electrolysis system, the hydrogen gas to the Sabatier reactor.

Various examples have been described. These and other examples are within the scope of the following claims.

What is claimed is:

1. A thermal process system, comprising:
a retort assembly comprising a retort chamber and configured to substantially contain one or more gases in the retort chamber during a thermal process;
a heating assembly comprising one or more heating elements and configured to heat the retort chamber; and
a vessel housing positioned around the retort chamber and the one or more heating elements and configured to maintain a pressure within the retort chamber.

2. The thermal process system of claim 1,
wherein the retort assembly is configured to form a concentration or partial pressure boundary for the one or more gases in the retort chamber, and
wherein the vessel housing is configured to form a pressure boundary between an interior volume of the vessel housing and an external environment.

3. The thermal process system of claim 1,
wherein the retort assembly further comprises a removable retort lid configured to contact a wall of the retort chamber at a sealing interface, and
wherein the sealing interface between the retort lid and the retort chamber is configured to form a contact seal.

4. The thermal process system of claim 3, wherein the contact seal is non-hermetic and does not include a gasket.

5. The thermal process system of claim 3, wherein each of the retort lid and the retort chamber comprises at least one of graphite, a ceramic, or a ceramic matrix composite.

6. The thermal process system of claim 5, wherein a surface of each of the retort lid and the retort chamber comprise a ceramic coating.

7. The thermal process system of claim 3, further comprising insulation material defining an inner insulated region, wherein the contact seal is enclosed within the inner insulated region.

8. The thermal process system of claim 3, wherein the vessel housing further comprises a preload assembly configured to directly or indirectly exert force on the retort lid.

9. The thermal process system of claim 1, wherein the retort assembly further comprises:
an inlet configured to discharge an inlet gas mixture into the retort chamber; and
an outlet configured to receive an outlet gas mixture from the retort chamber,
wherein the inlet and the outlet are configured to define flow through the retort chamber from the inlet to the outlet.

10. The thermal process system of claim 9,
wherein the retort assembly is configured to house one or more substrates within the retort chamber in a spatial arrangement defining channels between and around the one or more substrates, and
wherein the inlet and the outlet are configured to define flow of the gas mixtures through the channels.

11. The thermal process system of claim 1, wherein the one or more heating elements comprise at least one of:
electrical contacts configured to deliver a current to the retort chamber to generate resistive heat in the retort chamber; or
electrical contacts configured to deliver a current to the one or more substrates in the retort chamber to generate resistive heat in the one or more substrates.

12. The thermal process system of claim 1, further comprising insulation material surrounding the retort chamber.

13. The thermal process system of claim 12,
wherein the retort assembly further comprises a removable retort lid,
wherein the vessel housing comprises:
a top end cap configured to be detached from a remainder of the vessel housing; and
a bottom end cap configured to be detached from a remainder of the vessel housing, and
wherein the insulation material comprises:
a top portion configured to be removed from the vessel housing to provide access to the retort lid; and
a bottom portion configured to be removed from the vessel housing to access the one or more heating elements without accessing the retort lid.

14. The thermal process system of claim 1, further comprising a radiative foil at least partially surrounding the retort chamber.

15. The thermal process system of claim 1, further comprising a cooling duct positioned around at least a portion of the vessel housing and configured to flow cooling air across an outer surface of the vessel housing.

16. A system of generating hydrogen gas, comprising:
a pyrolysis reactor configured to generate the hydrogen gas from a hydrocarbon through pyrolysis, wherein the pyrolysis reactor comprises:
a retort assembly comprising a retort chamber and configured to:
substantially contain the hydrocarbon and the hydrogen gas in the retort chamber during the pyrolysis; and
house one or more fibrous substrates defining a deposition surface for carbon generated from the pyrolysis;
a heating assembly comprising one or more heating elements and configured to heat the retort chamber; and
a vessel housing positioned around the retort chamber and the one or more heating elements and configured to maintain a pressure within the retort chamber.

17. The system of claim 16,
wherein the pyrolysis reactor is configured to maintain a temperature of the retort chamber greater than about 850° C. during pyrolysis, and
wherein the vessel housing is configured to maintain a pressure of the retort chamber less than about 100 torr during pyrolysis.

18. The system of claim 16, wherein the hydrocarbon is methane, wherein the pyrolysis reactor is configured to generate carbon and a first portion of hydrogen gas from the methane, and wherein the system further comprises:
a Sabatier reactor configured to:
receive the first portion of hydrogen gas from the pyrolysis reactor and a second portion of hydrogen gas from an oxygen generation system;
generate the methane and water from carbon dioxide and the first and second portions of hydrogen gas; and
discharge the methane to the pyrolysis reactor; and
an oxygen generation system configured to:
receive the water from the Sabatier reactor;
generate oxygen and the second portion of hydrogen gas from the water; and
discharge the second portion of hydrogen gas to the Sabatier reactor.

19. A method, comprising:
receiving, by a retort assembly of a thermal process system, one or more gases; and
maintaining, by the thermal process system, the one or more gases at thermal process conditions by at least:
maintaining a temperature of the one or more gases in a retort volume within the retort chamber above about 400° C.;
maintaining a pressure boundary between a vessel volume within a vessel housing and an environment external to the vessel housing, wherein the retort chamber is positioned within the vessel housing; and
maintaining a concentration or partial pressure boundary of the one or more gases within the retort volume, wherein a pressure within the retort volume and a pressure within the vessel volume are substantially the same.

20. The method of claim 19, wherein maintaining the temperature of the one or more gases further comprises heating, by a heating assembly of the thermal process system, the retort chamber.
